(19) United States
(12) Patent Application Publication
(10) Pub. No.: US 2014/0238329 A1
(43) Pub. Date: Aug. 28, 2014

(54) METHOD AND DEVICE FOR OPERATING A LASER SPARK PLUG

(71) Applicants: Pascal Woerner, Korntal-Muenchingen (DE); Joerg Engelhardt, Ditzingen (DE); Martin Weinrotter, Vitoria-Gasteiz (ES)

(72) Inventors: Pascal Woerner, Korntal-Muenchingen (DE); Joerg Engelhardt, Ditzingen (DE); Martin Weinrotter, Vitoria-Gasteiz (ES)

(73) Assignee: ROBERT BOSCH GmbH, Stuttgart (DE)

(21) Appl. No.: 14/131,887

(22) PCT Filed: May 29, 2012
(86) PCT No.: PCT/EP2012/059954

§ 371 Date: May 15, 2014

(30) Foreign Application Priority Data
Jul. 12, 2011 (DE) 10 2011 079 017.9

(51) Int. Cl. F02P 23/04

(52) U.S. Cl. CPC F02P 23/045
USPC 123/143 B; 701/102

(57) ABSTRACT

In a method for operating a laser spark plug, the laser spark plug is actuated using an actuating device, in order to generate at least one laser ignition pulse, at least one variable characterizing the laser ignition pulse is ascertained using measuring techniques, and, from the at least one variable characterizing the laser ignition pulse, an operating condition of the laser spark plug is inferred.

### BACKGROUND OF THE INVENTION

1. Field of the Invention

The present invention relates to a method and device for operating a laser spark plug, in which the laser spark plug is actuated using an actuating device, in order to generate at least one laser ignition pulse.

2. Description of the Related Art

The usual operating methods and devices of the type named at the outset normally provide servicing of the laser spark plug or its components at regular time intervals, which gives rise to the disadvantage that, based on considerable fluctuations in the operation-conditioned wear of the laser spark plug (particularly combustion products such as oil ashes acting upon combustion chamber windows), either very short servicing intervals have to be provided, in order to detect in a timely manner a deterioration of the operating properties of the laser spark plug, or one has to accept that a laser spark plug that is no longer fit per se for operation will continue to be operated up to the end of a current servicing interval.

### BRIEF SUMMARY OF THE INVENTION

Accordingly, it is the object of the present invention to improve a method and a device of the type named at the outset to the extent that precise data on an operating state of the laser spark plug, in particular of the combustion chamber window, are able to be obtained, in order to adjust the servicing intervals for the laser spark plug to an actual wear.

According to the present invention, this object is attained in the method of the type named at the outset, in that at least one variable characterizing the laser ignition pulse is ascertained with measuring techniques, and from the at least one variable characterizing the laser ignition pulse, a conclusion is drawn on an operating state of the laser spark plug.

According to the present invention, the laser spark plug may be actuated, for example, by an actuating device during a servicing process, in order to generate at least one laser ignition pulse, and a variable characterizing the laser ignition pulse is ascertained using measuring techniques, in order to infer the operating condition of the laser spark plug, such as a current transmission loss of the combustion chamber window of the laser spark plug. The currently investigated laser spark plug may, for instance, be compared to a new system in which the combustion chamber window has a maximum transmission, according to expectations.

The present invention advantageously enables inferring the current operating condition, particularly a wear condition, of the laser spark plug or a component thereof (combustion chamber window, for example), whereby a statement may be obtained on the actually remaining, possible operating duration of the laser spark plug, or rather its combustion chamber window.

In one preferred specific embodiment it is provided that, from the at least one variable characterizing the laser ignition pulse, the transmission loss of a combustion chamber window of the laser spark plug and/or a remaining service life of the laser spark plug is inferred. These data ascertained according to the present invention may advantageously be used to fix the time of future servicing of the laser spark plug.

In a further advantageous specific embodiment, it is provided that a measuring device shall be situated, preferably temporarily, in an optical path of the laser spark plug, for the recording of the at least one variable. For example, after a disassembly of the laser spark plug from the target system, such as an internal combustion engine of a motor vehicle or a stationary gas engine, or the like, the measuring device may be inserted into the optical path of the laser spark plug. In a laser spark plug without an precombustion chamber, or rather without an additional component situated outside the combustion chamber window, such as masking means for the reduction of a soiling of the combustion chamber window and the like, the measuring device may be situated, according to the present invention, directly in the optical path of the laser spark plug, without having further to dismount or open the laser spark plug, because the ignition plasma is created in free air outside the LK, so that the laser beam is able to be measured after the laser spark plug.

In the case of such laser spark plugs, which have, for instance, masking means situated outside the combustion chamber window, or a precombustion chamber, in the case of a detachable connection of the masking means or the precombustion chamber to the laser spark plug, first the precombustion chamber or the masking means may be removed before the measuring device according to the present invention is inserted into the optical path of the laser spark plug.

The insertion, according to the present invention, of the measuring device for the recording of the at least one variable into the optical path of the laser spark plug advantageously enables a particularly precise recording of at least one variable characterizing the laser ignition pulse, and especially also well reproducible measured values.

In one further advantageous specific embodiment, it is provided that a gas pressure and/or an atmospheric composition in the vicinity of the laser spark plug, onto which the laser ignition pulses are focused, is influenced in such a way that the laser ignition pulse does not already effect plasma formation in the vicinity of the ignition point. This may be done, for instance, by providing low pressures or a vacuum and gases that are difficult to ionize, such as helium. In this case, a particularly precise measurement of the optical intensity or energy of the laser ignition pulse is possible, particularly without the risk of the destruction of components of the measuring device by plasma that might be created. In addition, the energy measurement or the intensity measurement is not corrupted, since the entire energy of the laser ignition pulse is available for the measurement if no plasma is being generated in the medium surrounding the ignition point.

In another advantageous specific embodiment, it is provided that the at least one variable characterizing the laser ignition pulse characterizes an optical power density. In a particularly preferred manner, this may involve an optical power density in a range of wavelength of the laser ignition pulse. In this case, according to the present invention, a statement may be made directly on the intensity of the laser ignition pulse, or rather, a transmission ability of a combustion chamber window of the laser spark plug that seals a housing of the laser spark plug from the surroundings. Alternatively or in addition, the at least one variable characterizing the laser ignition pulse may be an optical power density in a wavelength range of a plasma generated using the laser ignition pulse, so that, within the scope of the method according to the present invention, one may also infer a plasma formation effected by the laser spark plug to be tested.

In yet another advantageous specific embodiment, it is provided that the laser spark plug have a precombustion chamber having at least one overflow channel, which makes possible a fluid connection between the precombustion chamber and a space region surrounding the precombustion chamber, and that a light-conducting device, particularly a light conducting fiber, is introduced from the outside through the overflow channel into an inner chamber of the precombustion chamber, in order to take up radiation from the inner chamber of the precombustion chamber. It is thereby advantageously made possible to obtain data on physical variables from the optical path of the laser spark plug, especially an intensity or an energy of the laser ignition pulses, without dismounting of the precombustion chamber being required This variant of the present invention is consequently usable even in laser spark plugs, in which the precombustion chamber is connected nondetachably to the remaining laser spark plug, on the housing of the laser spark plug. The same applies for laser spark plugs having masking means situated on the outside of the combustion chamber window.

In one further advantageous specific embodiment, it is provided that masking means, that may be situated on the laser spark plug, and/or a precombustion chamber module be separated from the laser spark plug, in order to record the variable characterizing the laser ignition pulse. In this variant of the method, the measuring device according to the present invention may be inserted directly into the optical path of the laser spark plug.

In order to enable as precise a measurement as possible, following a further advantageous specific embodiment, at least one measuring device, for recording the at least one variable, is able to be connected detachably to the laser spark plug, in particular, to a housing of the laser spark plug. For instance, a measuring device for recording the at least one variable characterizing the laser ignition pulse may be situated in a housing that is developed in such a way that it is able to be connected, particularly detachably connected, to the laser spark plug, or rather to a precombustion chamber module and/or a masking module of the laser spark plug.

As the detachable connection, for instance, a plug connection and/or a latching connection and/or a screw connecting come into consideration. In particular, a measuring module for carrying out the method according to the present invention may be developed so that it has a housing which essentially corresponds to the shape of a precombustion chamber module for the laser spark plug. In this case, the measuring module may be screwed onto the laser spark plug, analogously to a usual precombustion chamber module, which enables a particularly precise positioning of a measuring device, situated in the measuring module, in the optical path of the laser spark plug. In particular, in this instance, a specified distance may be set between the measuring device and the laser spark plug, for example, the outer surface of the combustion chamber window of the laser spark plug.

In a further advantageous specific embodiment, it is provided that at least one component of the laser spark plug, especially a combustion chamber window, be cleaned, preferably using a cleaning fluid, whereby an operating capability of the laser spark plug may advantageously be restored. In particular, the transmission ability of the combustion chamber window may be increased again.

According to another specific embodiment of the method according to the present invention, the cleaning is quite especially advantageously carried out as a function of an operating condition of the laser spark plug ascertained previously, especially a current transmission ability of the combustion chamber window of the laser spark plug. Because of this, an especially efficient and targeted cleaning of the combustion chamber window or of the laser spark plug is able to take place, which takes into account the current wear condition of the respective component. On the one hand, this extends the time between servicing, and on the other hand, costs are saved for cleaning, since they are able to be adjusted to the current wear condition of the laser spark plug or rather the combustion chamber window.

In yet another advantageous specific embodiment of the method according to the present invention, it is provided that, as a function of the previously ascertained operating condition of the laser spark plug, a concentration of at least one effective substance component, particularly acetic acid, and/or an exposure time of a cleaning fluid containing a, or rather the effective substance component is selected. This makes possible an especially efficient and resource-conserving cleaning of the laser spark plug, or rather its combustion chamber window which, at the same time, takes into account in an optimal way the current wear condition.

In still another specific embodiment of the method according to the present invention, it is provided that the cleaning fluid be water (H₂O) and that it have a volume proportion of about 10% to about 80% of acetic acid, preferably about 15% to about 50% of acetic acid (C₂H₄O₂).

Alternatively or in addition, other acids, or rather aqueous solutions of acids may also be used as effective substance components. In particular, such acids may be used which are possibly able to dissolve combustion residues located on the combustion chamber window, such as oil ashes (calcium sulfate compounds (anhydrides), calcium phosphate compounds).

Alternatively or in addition, pure water, particularly distilled water, may also be used, if necessary in combination with ultrasound. Ultrasound may also be used in connection with acids or aqueous solutions of acids.

A multi-stage cleaning method may also advantageously provide the successive application, one after another, using different active substances or active substance solutions to the components to be cleaned. Alternatively or in addition to water and/or acids, the use of alcohols, such as ethanol, is also conceivable.

### BRIEF DESCRIPTION OF THE DRAWINGS

FIG. 1 shows a simplified flow chart of one specific embodiment of the method according to the present invention.

FIG. 2 shows a flow chart of another specific embodiment of the method according to the present invention.

FIG. 3 shows schematically a simplified block diagram of a device for operating the laser spark plug according to a first specific embodiment.

FIG. 4 shows a simplified block diagram which shows the construction of the measuring device according to the present invention on a laser spark plug.

FIG. 5 shows a simplified block diagram of an additional application case of the measuring device according to the present invention.

FIG. 6 shows an end region of the laser spark plug facing the combustion chamber, having a precombustion chamber, into which a light-conducting device of a measuring device according to a further specific embodiment of the present invention is inserted.

FIG. 7 shows another specific embodiment of the measuring device according to the present invention.

FIG. 8 and FIG. 9 shows additional specific embodiments of the measuring device of the operating device according to the present invention.

FIG. 10 show a schematic block diagram for illustrating a cleaning process of a laser spark plug according to the present invention.

FIG. 11 shows a simplified block diagram of a cleaning device according to the present invention.

FIG. 12 shows a simplified block diagram according to an additional specific embodiment of the present invention.

### DETAILED DESCRIPTION OF THE INVENTION

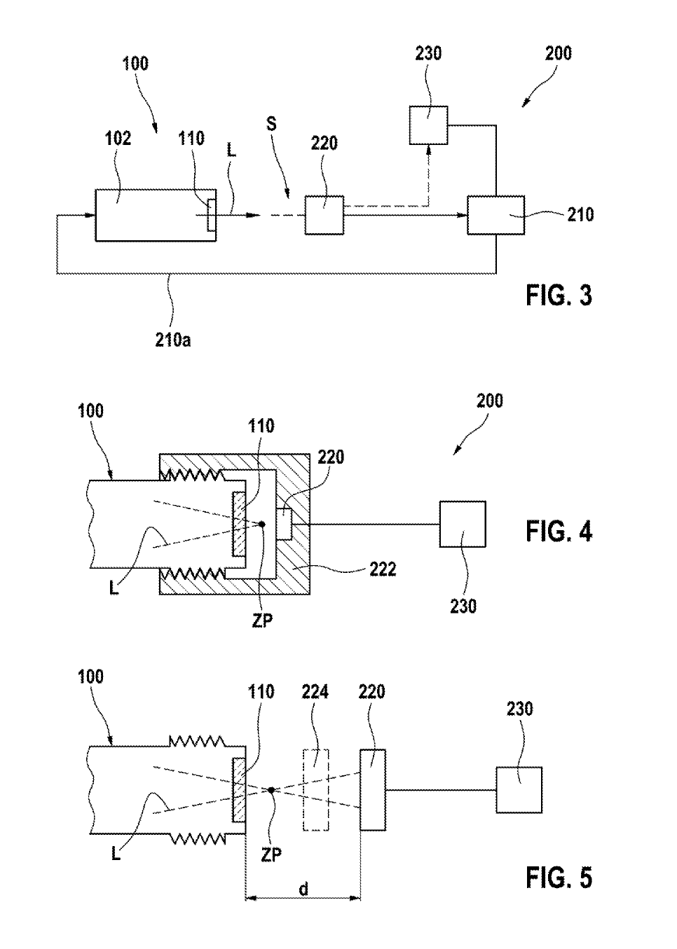

FIG. 3 schematically shows a simplified block diagram of a laser spark plug 100 and a device 200 assigned to laser spark plug 100, for operating laser spark plug 100.

Laser spark plug 100 has a housing 102 and a combustion chamber window 110, through which laser radiation L provided by laser spark plug 100 is able to be radiated from the inside of housing 102 into a space region surrounding the axial end region of laser spark plug 100 outside of housing 102. In a mounting position of laser spark plug 100 in an internal combustion engine (not shown) the space region surrounding the axial end region of laser spark plug 100 is a combustion chamber of the internal combustion engine, for example.

According to the present invention, device 200 is equipped with an actuating device 210, which is able to actuate laser spark plug 100, in a manner known per se, in such a way electrically and/or optically, that laser spark plug 100 generates at least one laser ignition pulse L. A corresponding signal connection or control connection is designated in FIG. 3 by reference numeral 210a.

Device 200 also has at least one measuring device 220, which is developed to ascertain, by measuring techniques, at least one variable characterizing laser ignition pulse L. For this, measuring device 220 may have at least one optoelectric sensor, for example, or other sensors or sensor devices, which enable recording optical and/or electrical or electromagnetic and/or acoustical signals and pressure signals (e.g. using a microphone). The at least one measuring variable provided by measuring device 220, which characterizes laser ignition pulse L, is transmitted via a corresponding signal connection from measuring device 220 to actuating device 210 for further evaluation. Alternatively to the passing on of measured signals from measuring device 220 to actuating device 210, a direct transmission of the measured data from measuring device 220 to evaluation unit 230 may also take place (cf. the dashed arrow in FIG. 3) which is provided in device 200 for evaluating the measured data of measuring device 220.

Device 200 may have, in a manner known per se, at least one arithmetic unit, such as, for instance, a microcontroller and/or a digital signal processor (DSP) or the like, in order to evaluate, and process further, measured signals which correspond to the at least one variable characterizing laser ignition pulse L.

It is thereby advantageously possible to obtain data on a current operating condition of laser spark plug 100. In particular, in response to an analysis of laser ignition pulses L generated by laser spark plug 100, one is able to infer transmission losses in the area of combustion chamber window 110. Such transmission losses may come about by deposits of combustion products, such as oil ashes on an outer surface of combustion chamber window 110 over the operating duration of laser spark plug 100 in an internal combustion engine (not shown).

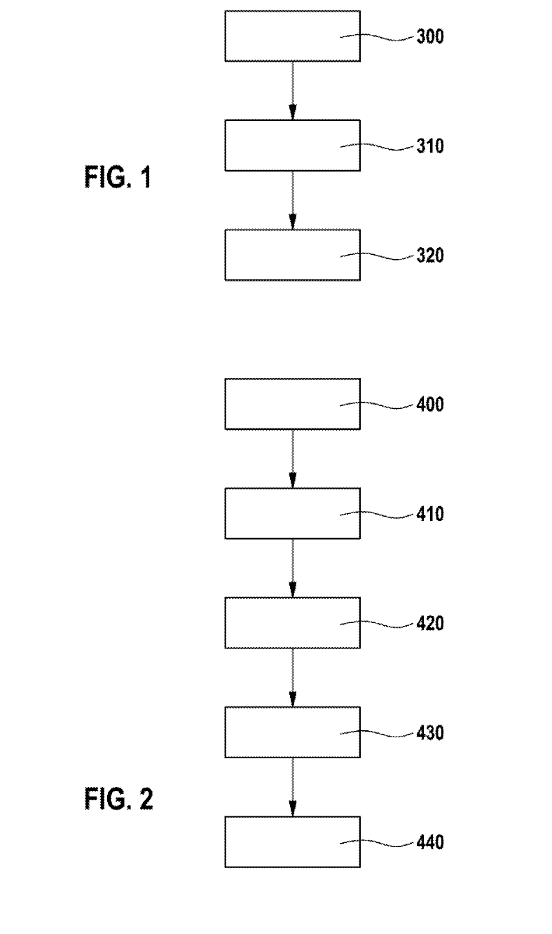

FIG. 1 shows a simplified flow chart of a first specific embodiment of an operating method according to the present invention. In a first step 300, laser spark plug 100 is actuated using actuating device 210 (FIG. 3) in such a way that it generates at least one ignition pulse L.

Then, in step 310 (FIG. 1) at least one variable characterizing laser ignition pulse(s) L is/are ascertained by measuring techniques using measuring device 220 (FIG. 3).

Thereafter, in step 320, from the at least one variable characterizing laser ignition pulse L, one is able to infer the operating condition of laser spark plug 100, particularly to infer a current transmission behavior of combustion chamber window 110.

Subsequently, the appropriate cleaning of the laser spark plug or its components is able to take place.

Especially advantageously device 200, from the measured data received, for instance, by comparing the current measured data to a reference system or a new system, is also able to infer the remaining service life of laser spark plug 100. The method according to the present invention thereby advantageously makes possible specifying a remaining operating period for laser spark plug 100, at the end of which there is a new servicing process.

In a particularly preferred manner, laser spark plug 100 is removed from its target system, such as an internal combustion engine of a motor vehicle or from a stationary gas engine, in order to be operated for test purposes by device 200 according to the present invention.

FIG. 2 shows a simplified flow chart of an additional specific embodiment of the method according to the present invention. This method variant comes into consideration particularly when monitoring such laser spark plugs as are provided with a precombustion chamber or other type of module that is situated outside combustion chamber window 110 (FIG. 3), and could therefore impair a precise measurement while using device 200 according to the present invention.

In a first step 400, a detachable connection between the precombustion chamber module or a masking means or another type of device situated outside combustion chamber window 110 (FIG. 1) to a housing 102 of laser spark plug 100 is detached. After that, in step 410, device 200 according to the present invention, or at least measuring device 220 is situated in optical path S (FIG. 3) of laser spark plug 100, for instance, directly outside combustion chamber window 110. Then, in step 420, actuating takes place of laser spark plug 100 for generating at least one laser ignition pulse L. In addition, in step 420, according to FIG. 2, the ascertaining by measuring techniques of at least one variable characterizing laser ignition pulse L takes place.

In a subsequent step 430, using device 200 according to the present invention, one may infer the operating condition of laser spark plug 100, particularly the remaining service life, and in step 440 cleaning of laser spark plug 100 is carried out, especially of an outer surface of combustion chamber window 110 (FIG. 3).

Cleaning 440 advantageously takes place, according to the present invention, as a function of the current operating condition of the laser spark plug ascertained previously in step 430. A current transmission loss of combustion chamber window 110 in particular may thereby be assessed precisely, and parameters of cleaning process 440 are able to be adjusted to the current wear condition of laser spark plug 100, whereby cleaning is possible that is particularly efficient and at the same time is gentle on the optical surface of combustion chamber window 110.

FIG. 4 shows another specific embodiment of device 200 according to the present invention. In this variant of the present invention, measuring device 220 is integrated into a measuring module 222, which has a housing that is essentially pot-shaped and is designed to be able to be detachably connected to laser spark plug 100 or rather its housing 102 (FIG. 3). Measuring module 222 may have an inner thread, for instance, which cooperates with an outer thread of laser spark plug 100, via which laser spark plug 100, in its normal operation, is screwed into a cylinder head.

Because of the detachable connection, described above, of measuring module 222 with laser spark plug 100, measuring device 220 is able to be situated especially precisely in optical path S (FIG. 3) of laser spark plug 100, for instance, having a specified distance from an ignition point ZP, onto which laser radiation L, provided by laser spark plug 100 is bundled.

The evaluation of the data obtained using measuring device 220 may be carried out by an evaluation unit 230 of device 200 situated at a distance, analogously to the system described above described with reference to FIG. 3. The connection of measuring device 220 to evaluation unit 230 may, for instance, take place using an electrical and/or optical cable. It is further conceivable that one might provide a wireless data connection between measuring device 220 and evaluation unit 230, if necessary, a preamplification and/or other conditioning of the recorded measuring signal having to be provided for the subsequent wireless data transmission locally in measuring module 222.

FIG. 5 shows an additional specific embodiment of the present invention, in which measuring device 220 is situated at a certain distance d from ignition point ZP or an outer surface of combustion chamber window 110. Provided distance d does not fall below a specified minimum value, it may be ensured that measuring device 220, which may, for example, have optoelectronic sensors, is not exposed to too high a radiation intensity of laser ignition pulse L, which could lead to a destruction of measuring device 220.

For instance, distance d may advantageously be selected so that it corresponds at least to the distance of ignition point ZP from the outer surface of combustion chamber window 110. In this case, there comes about in FIG. 5, to the right of ignition point ZP, a widening of laser radiation L that is focused on ignition point ZP, so that the intensity of laser radiation L present in the vicinity of measuring device 220 is sufficiently small so as not to destroy measuring device 220.

Alternatively or in addition, a measuring optical system (also referred to as a light-conducting device) 224 may also be provided in the optical path between ignition point ZP and measuring device 220, which is developed to reduce the power density at the location of measuring device 220. This may take place, for example, via a widening or a collimation of laser radiation L. Alternatively or in addition, measuring optical system 224 may also have the effect of damping laser radiation L by a specifiable degree.

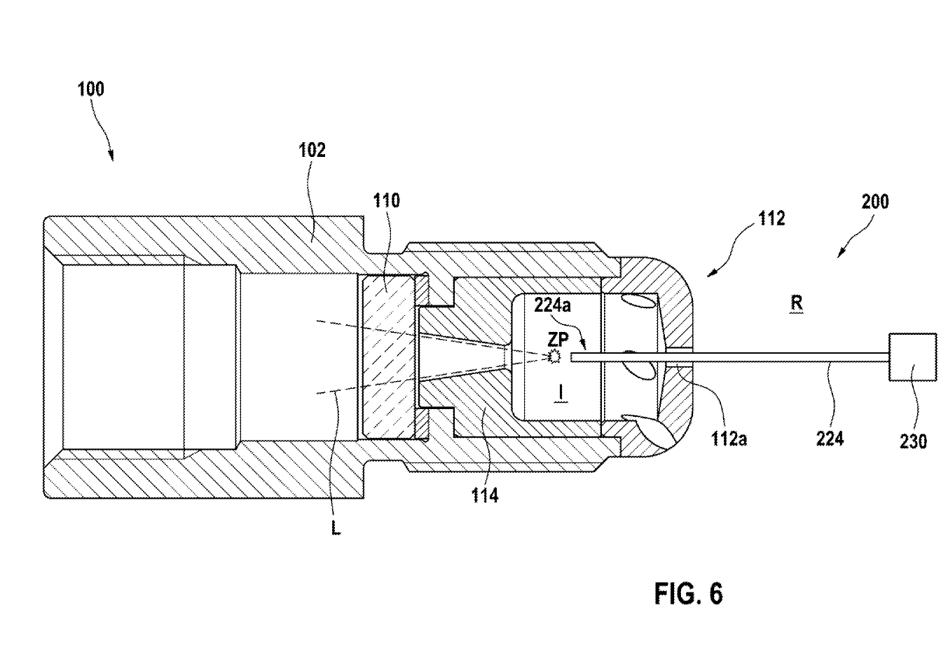

FIG. 6 shows a partial cross section of an end region of a laser spark plug 100, which has a precombustion chamber 112. For the recording of the variable(s) characterizing laser ignition pulse L, operating device 200 has present a light-conducting device 224, which, as may be seen in FIG. 6, is inserted through an overflow opening or overflow channel 112a of precombustion chamber 112, which produces a fluid connection between inner chamber 1 of precombustion chamber 112 and outer chamber R, into precombustion chamber 112. An end section 224a of light-conducting device 224 located in inner chamber 1 is situated in such a way in the vicinity of ignition point ZP that a measure of generated laser radiation L required for the evaluation according to the present invention is able to be supplied to evaluation device 230.

In the configuration illustrated in FIG. 6, laser spark plug 100, additionally to precombustion chamber 112 also has masking means 114, which are situated between combustion chamber window 110 and precombustion chamber module 112. Masking means 114 are used to protect sub-ranges of the outer surface of combustion chamber window 110 from being acted upon by dirt particles originating from precombustion chamber 112, and at the same time to allow to enter laser radiation L, provided by laser spark plug 100, into inner chamber 1 of precombustion chamber 112. It should be understood that device 200 according to the present invention and the method are also able to be used for laser spark plugs having no masking means 114.

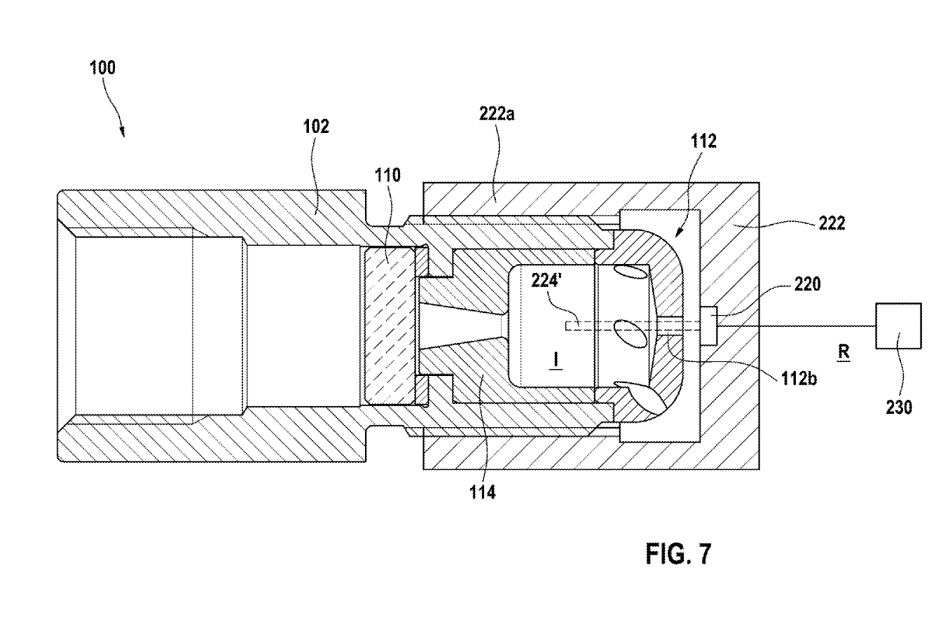

FIG. 7 shows a further variant of the present invention, in which a measuring module 222 is detachably connected to laser spark plug 100 to carry out the measurement according to the present invention. In this case, the detachable connection is implemented by a screw connection in region 222a of measuring module 222, in which an inner thread is situated, which cooperates with the outer thread of laser spark plug 100 and precombustion chamber 112.

In the configuration illustrated in FIG. 7, a central overflow channel 112b is provided in the precombustion chamber wall. Measuring device 220 is therefore integrated so into measuring module 222 or the corresponding housing, that, at the correct mounting position of measuring module 222 on laser spark plug 100, it gets to lie approximately opposite the exit opening of overflow channel 112b, so that radiation exiting from inner chamber 1 of precombustion chamber 112 through overflow channel 112b is able to be recorded by measuring device 220. Alternatively or in addition, measuring module 222 may also be provided with a light-conducting device 224′, which extends approximately coaxially to a longitudinal axis of measuring module 222, and is consequently able to be inserted again into overflow channel 112b during the fastening of measuring module 222 on laser spark plug 100. In this way, because of light-conducting device 224′, radiation to be analyzed within the scope of the measuring method according to the present invention is able to be passed on directly from inner chamber 1 of precombustion chamber 112 to measuring device 220. Light-conducting device 224′ may be developed to be flexible or preferably also to be rigid, in order to make possible a coupling-in surface for taking up the radiation that is to be measured, relative to ignition point ZP.

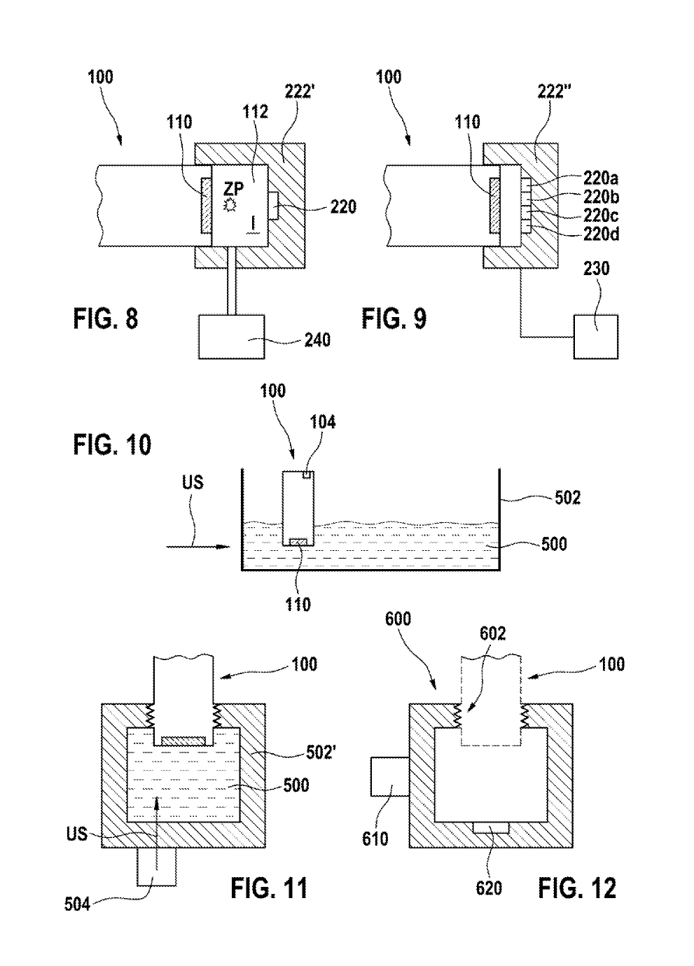

FIG. 8 shows a further specific embodiment of the present invention, in which measuring module 222′ is assigned to a device 240. Device 240 is developed to influence a pressure in inner chamber 1 of precombustion chamber 112 and/or an atmospheric composition, such as a gas filling, of inner chamber 1 in such a way that the measurement of laser radiation L (FIG. 3), according to the present invention, is able to be carried out particularly precisely.

In particular, by the provision of a gas pressure that is greater than a specifiable minimum value in inner chamber 1, a contribution is able to be made to a laser ignition pulse L, generated by laser spark plug 100, not already leading to a plasma formation in the vicinity of ignition point ZP. This makes possible an especially precise detection of the laser radiation provided by laser spark plug 100. At the same time, possible damage is avoided to measuring device 220 by contact with plasma produced.

Alternatively or in addition to the setting of the gas pressure in inner chamber 1 of precombustion chamber 112, device 240 may also be developed to apply a specifiable gas, particularly a protective gas or a gas mixture to inner chamber 1. For instance, for carrying out the measurement according to the present invention, device 240 may flood measuring module 222′ with helium or another inert gas.

Furthermore, device 240 may have appropriate fluidic control means (valves, etc.), to enable producing the protective gas atmosphere described above and/or to refill inner chamber 1 with environmental air.

FIG. 9 shows a further specific embodiment of the present invention, in which a measuring module 222″, that is able to be connected to laser spark plug 100, has altogether four measuring devices 220a, 220b, 220c, 220d. First measuring device 220a may be developed to detect an optical power density in a wavelength range of laser ignition pulse L, for example. Second measuring device 220b, by contrast, is developed to detect an optical power density in a wavelength range of a plasma generated by the laser ignition pulse, so that, in addition to the direct assessment of generated laser radiation L, quantifying variables characterizing the ignition plasma is also possible.

Third measuring device 220c may be developed to detect an acoustical signal, whereby data on the development and the spreading of the plasma in the measured volume between combustion chamber window 110 and the housing of measuring module 222″ are also able to be obtained.

A fourth measuring device 220d may, for instance, be provided to record the environmental parameters such as pressure, temperature, etc.

The evaluation of the data recorded using the measuring devices again preferably takes place via evaluation unit 230.

FIG. 10 shows a system, according to the present invention, for cleaning laser spark plug 100, in which a fluid container 502 is provided, which is filled with a cleaning fluid 500. Cleaning fluid 500 may be an aqueous solution of acetic acid, for instance. As may be seen in FIG. 10, according to the present invention, laser spark plug 100 is dipped into cleaning fluid 500 only so far that an electric contact area 104 does not yet come into contact with cleaning fluid 500.

The cleaning process of laser spark plug 100, or rather of combustion chamber window 110, according to the present invention, takes place as a function of the operating condition of laser spark plug 100 or rather combustion chamber window 110, obtained previously using the method according to the present invention according to FIG. 1 or FIG. 2, so that a targeted and yet gentle cleaning is possible.

The effect of the cleaning fluid may be further reinforced by container 502, or rather cleaning fluid 500 located in it, being acted upon by ultrasound US.

Instead of a diluted acetic acid solution, pure water may also be used as the cleaning fluid, especially distilled water, preferably in connection with ultrasound US.

In a particularly preferred manner, a concentration of at least one active substance component of the cleaning fluid, acetic acid in the present case, and/or a dwell time of the cleaning fluid is selected as a function of the operating condition of laser spark plug 100 or rather combustion chamber window 110 that was previously ascertained by measuring techniques.

In one particularly preferred specific embodiment, it is provided that cleaning fluid 500 be water and that it have a volume component of about 10% to about 80% of acetic acid, preferably about 15% to about 50%.

Other diluted acids may also be used, particularly if they are suitable for dissolving oil ashes, such as calcium sulfate compounds (anhydrides) and/or calcium phosphate compounds.

If the transmission loss of combustion chamber window 110, ascertained by measuring techniques, amounts to between about 30% to about 50%, it is suggested according to the present invention, that cleaning fluid 500 be allowed to take effect up to a maximum of about 30 minutes on the outer surface of combustion chamber window 110. The cleaning process preferably takes place so that no significant flow of cleaning fluid 500 takes place in the vicinity of the window surface.

At smaller window transmission losses of about 0% to about 30%, a correspondingly smaller exposure time may be used, of preferably about 0 minutes to about 15 minutes.

The acetic acid proportion for the cleaning processes described above preferably amounts to about 30%.

The dwell time of cleaning fluid 500 may advantageously be reduced if the cleaning process is supported by mechanical measures (streaming, pressure cleaning, wiping of the surface). In general, cleaning fluid 500 may be at room temperature. An increased temperature for cleaning fluid 500 is also possible, and acts, in turn, on the exposure time required.

In one additional specific embodiment of the present invention, it is established how much pulse energy a laser ignition pulse L has, using device 200 according to the present invention. Moreover, a laser ignition process triggered by actuating device 210 may be monitored as to whether, as a result of laser ignition pulse L, an ignition plasma is created or not in the vicinity of ignition point ZP.

Beyond that, it may be provided that plasma stability be rated. For this purpose, a plurality of laser ignition pulses L are generated, that are successive in time, and it is checked, using device 200, whether in response to each laser ignition pulse L plasma is also yielded as a result of laser ignition pulse L.

For this, measuring device 220 may have a photodiode, for example, whose spectral sensitivity is coordinated with the spectrum, or rather the spectral range of the plasma, which have a particularly high power density. In the same way as all other optical measurements, the checking of the plasma stability, according to the present invention, may also be done locally, that is, in the vicinity of the ignition point, or also through an overflow channel 112a (FIG. 6) of a precombustion chamber 112, if present.

Device 200 according to the present invention further makes possible the measurement of plasma intensity, so that one may advantageously infer the inflammation properties of laser spark plug 100, and consequently, the maximum power to be achieved of an internal combustion engine equipped with laser spark plug 100. In addition, from the plasma intensity one may also infer a remaining service life of laser spark plug 100. The measurement of the plasma intensity may, for instance, take place in that measuring device 220 is equipped with a photodiode, and the intensity of a plasma generated by laser ignition pulse L is recorded using measuring techniques. A downstream evaluation of the recorded data may be calibrated, for example, to a plasma intensity of a laser spark plug 100 in a new condition. Then, using the operating method according to the present invention, in the case of an already worn out laser spark plug, from a drop in the intensity of the plasma, one is able to infer the wear.

Alternatively or in addition to the photodiode, a calorimeter may also be provided, which, via a measurement of the pressure superelevation caused by the appearance of the plasma in a closed spatial volume, enables one to infer the ignition energy deposited in the ignition plasma.

Alternatively or in addition, a “plasma loudness” may also be measured, using acoustical sensors. For example, using a microphone, the loudness of the shock wave may be ascertained which is emitted by an ignition plasma, and this signal may alternatively or in addition be evaluated by device 200 according to the present invention, in order to infer a current operating condition or a state of wear of laser spark plug 100. A greater loudness corresponds to a greater plasma energy, for instance.

All the measurements named above using measuring device 220 may be made at environmental pressure or rather, at generally standard conditions (standard pressure of 1.013 mbar, standard temperature 25° C.) or even at deviating environmental conditions. In particular, by device 200 according to the present invention, for instance, while using device 240 (FIG. 8), the setting of a pressure increased over standard pressure may also take place for the measuring method, or even the providing of an atmospheric composition (protective gas, for example), which leads advantageously to more precise measuring results, since especially the mechanisms for the forming of plasma as a result of the laser ignition pulses L are pressure-dependent.

In another advantageous specific embodiment of device 200 according to the present invention, the results of the measurements obtained according to the present invention are stored and/or compared to reference data stored in a data bank. The reference data may for instance be measured values of a new system, that is, a laser spark plug 100 having a combustion chamber window 110 having maximum transmission.

In one additional advantageous specific embodiment it may also be provided that a gas pressure in the vicinity of ignition point ZP should be reduced, in order to increase an intensity limit, in the vicinity of ignition point ZP, for the formation of a non-resonant plasma breakthrough to the extent that there will not be already a plasma formation as a result of the irradiation of laser ignition pulse L. In this case, an energy measurement of the laser ignition pulse is advantageously possible using measuring device 220, without this measurement being disturbed by the appearance of a plasma.

The appearance of a plasma may also be ascertained, for example, by a measuring device having at least one photodiode. The measuring device preferably has a photodiode having maximum spectral sensitivity in the wavelength range of maximum emission of plasma, for instance, at 400 nm. Provided laser spark plug 100 has a laser-active solid that is pumped optically, in order to generate laser ignition pulses L (for example, a passively Q-switched solid laser), a filtering device may advantageously be provided for the measuring device which filters out a wavelength of the optical pump radiation for the laser-active solid (808 nm at Nd: YAG) and a wavelength of laser ignition pulses L (1064 nm at Nd: YAG).

The filtering may take place, for example, by an optical filter, which is optimized for maximum damping of the wavelength of 1064 nm, or also using as high-pass filter in a signal evaluation downstream from measuring device 220, which is carried out in evaluation unit 230, for example.

FIG. 11 shows a simplified block diagram of a cleaning device according to the present invention, according to an additional specific embodiment, in which a housing 502′ accommodating a cleaning fluid 500 is designed to be able to be connected detachably to laser spark plug 100, and is consequently able to be mounted intermittently on laser spark plug 100 for the cleaning 440 (FIG. 2). Because of the smaller fluid volume in comparison to an immersion bath according to FIG. 10, cleaning is possible that is particularly cost-saving. Furthermore, a laser spark plug 100, having a unit 502′ (FIG. 11), that is in servicing is able to be situated spatially in a very flexible manner. Optionally, a housing unit 502′ may also have an ultrasound generator 504 assigned to it, which applies ultrasound US to fluid 500.

FIG. 12 shows a simplified block diagram of an additional specific embodiment of the present invention. A combined measuring and cleaning module 600 for the detachable connection to at least one laser spark plug 100 has a screw thread 602 for example, for screwing in a laser spark plug 100. Module 600 has means 610 which are developed to produce a specifiable atmospheric composition (gas, protective gas or mixtures thereof, e.g. also environmental air) in the inner chamber of module 600, in order to create specified conditions for the generation and measurement of laser ignition pulses L (FIG. 3). Measuring device 620 has a functionality comparable to components 220 that were described above. Means 610 may advantageously also be developed additionally to apply a cleaning fluid and/or ultrasound to the inner chamber of module 600, so that, besides the measurement of laser ignition pulses, advantageously cleaning of laser spark plug 100 or rather its combustion chamber window may also be carried out, without this requiring any further apparatus. The aspects of the invention described above with reference to FIGS. 1 through 12 may also be optionally combined with one another.

1-15. (canceled)

16. A method for operating a laser spark plug, comprising:
actuating the laser spark plug using an actuating device in order to generate at least one laser ignition pulse;
ascertaining at least one variable characterizing the laser ignition pulse using a measuring technique; and
inferring an operating condition of the laser spark plug based on the at least one variable characterizing the laser ignition pulse.

17. The method as recited in claim 16, wherein, based on the at least one variable characterizing the laser ignition pulse, at least one of a transmission loss of a combustion chamber window of the laser spark plug and a remaining service life of the laser spark plug is inferred.

18. The method as recited in claim 17, wherein a measuring device for recording the at least one variable is positioned in an optical path of the laser spark plug.

19. The method as recited in claim 17, wherein at least one of a gas pressure and an atmospheric composition in the vicinity of an ignition point of the laser spark plug is influenced in such a way that the laser ignition pulse does not effect a plasma formation in the vicinity of the ignition point.

20. The method as recited in claim 17, wherein the at least one variable characterizing the laser ignition pulse characterizes an optical power density at least one of (i) in a wavelength range of the laser ignition pulse and (ii) in a wavelength range of a plasma generated using the laser ignition pulse.

21. The method as recited in claim 17, wherein the laser spark plug has a precombustion chamber having at least one overflow channel which provides a fluid connection between the precombustion chamber and a space region surrounding the precombustion chamber, and wherein a light-conducting device is introduced from outside through the overflow channel into an inner chamber of the precombustion chamber in order to take up radiation from the inner chamber of the precombustion chamber.

22. The method as recited in claim 17, wherein at least one of a masking unit situated on the laser spark plug and a precombustion chamber module is separated from the laser spark plug in order to record the at least one variable characterizing the laser ignition pulse.

23. The method as recited in claim 17, wherein at least one measuring device for recording the at least one variable characterizing the laser ignition pulse is connected detachably to the laser spark plug.

24. The method as recited in claim 17, wherein at least one component of the laser spark plug is cleaned using a cleaning fluid.

25. The method as recited in claim 24, wherein the cleaning is carried out as a function of a previously ascertained operating condition of the laser spark plug.

26. The method as recited in claim 25, wherein, as a function of a previously ascertained operating condition of the laser spark plug, at least one of (i) a concentration of at least one active agent component and (ii) a dwell time of the cleaning fluid having the active agent component is selected.

27. The method as recited in claim 25, wherein the cleaning fluid is water and has a volume proportion of about 15 percent to about 50 percent acetic acid.

28. A device for operating a laser spark plug, comprising:
an actuating device for actuating the laser spark plug in order to generate at least one laser ignition pulse;
means for ascertaining at least one variable characterizing the laser ignition pulse using a measuring technique; and
means for inferring an operating condition of the laser spark plug based on the at least one variable characterizing the laser ignition pulse.

29. The device as recited in claim 28, wherein a measuring device positioned in an optical path of the laser spark plug records the at least one variable characterizing the laser ignition pulse, and wherein the measuring device is a part of a measuring module configured to be connected detachably to at least one of the laser spark plug, a housing of the laser spark plug, and a precombustion chamber of the laser spark plug.

30. The device as recited in claim 29, wherein a light-conducting fiber is provided in order to take up optical radiation of the laser spark plug.
